(19) United States
(12) Patent Application Publication
(10) Pub. No.: US 2014/0349825 A1
(43) Pub. Date: Nov. 27, 2014

(54) ROLL-TO-ROLL PRESS DEVICE WITH TENSION CONTROLLER

(71) Applicant: HON HAI PRECISION INDUSTRY CO., LTD., New Taipei (TW)

(72) Inventor: CHIA-LING HSU, Tu-Cheng (TW)

(73) Assignee: HON HAI PRECISION INDUSTRY CO., LTD., New Taipei (TW)

(21) Appl. No.: 14/285,655

(22) Filed: May 23, 2014

(30) Foreign Application Priority Data
May 23, 2013 (TW) 102118138

(51) Int. Cl. B31C 11/00

(52) U.S. Cl. CPC B31C 11/00
USPC 493/24

(57) ABSTRACT

A roll-to-roll press device includes an unreeling shaft, a pressing unit, a reeling shaft, and a tension controller. The unreeling shaft unreels substrate film reeled thereon. The pressing unit presses the substrate film to print microstructures on the substrate film. The reeling shaft reels the pressed substrate film thereon. The tension controller adjusts a tension of the substrate film according to a thickness of a coil of the substrate film on the reeling shaft.

### FIELD

The present disclosure relates to film producing devices, and particularly to a roll-to-roll press device with tension controller.

### BACKGROUND

Many optical films are produced by roll-to-roll press devices. A roll-to-roll press device can include an unreeling shaft for providing a substrate film, and a reeling shaft for reeling the substrate film after the substrate film is pressed.

### BRIEF DESCRIPTION OF THE DRAWING

The components of the drawing are not necessarily drawn to scale, the emphasis instead being placed upon clearly illustrating the principles of the embodiments of the present disclosure.

FIG. 1 is a diagrammatic view of an embodiment of a roll-to-roll press device, the roll-to-roll press device including a tension controller.

FIG. 2 is a block diagram of the tension controller of the roll-to-roll press device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

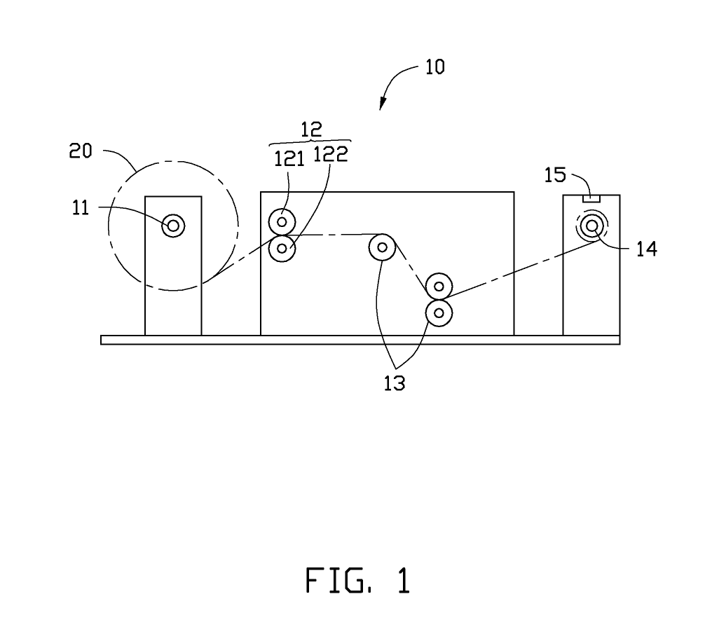

FIG. 1 illustrates an exemplary embodiment of a roll-to-roll press device 10 of the present disclosure. The roll-to-roll press device 10 is configured for pressing a substrate film 20 to generate a desired optical film. The roll-to-roll press device 10 includes an unreeling shaft 11, a pressing unit 12, a guiding mechanism 13, a reeling shaft 14, and a tension controller 15. The pressing unit 12 is positioned between the unreeling shaft 11 and the winding shaft 14. The tension controller 15 is positioned adjacent to the winding shaft 14. The substrate film 20 is unreeled from the unreeling shaft 11, and the substrate film 20 passes through the pressing unit 12 and the guiding mechanism 13. The substrate film 20 is wound around the winding shaft 14 after passing through the pressing unit 12 and the guiding mechanism 13.

The unreeling shaft 11 is rotatable to unreel the substrate film 10. In the embodiment, the unreeling shaft 11 is controlled by a controller (not shown) to rotate at a constant speed.

The pressing unit 12 is configured to press the substrate film 20, and print microstructures on at least one surface of the substrate film 20. In this embodiment, the pressing unit 12 includes a first pressing roller 121 and a second pressing roller 122. The substrate film 20 is pressed between the first pressing roller 121 and the second pressing roller 122.

The guiding mechanism 13 is configured to guide the substrate film 20 from the pressing unit 12 to the winding shaft 14.

The winding shaft 14 is configured for winding the substrate film 20 thereon.

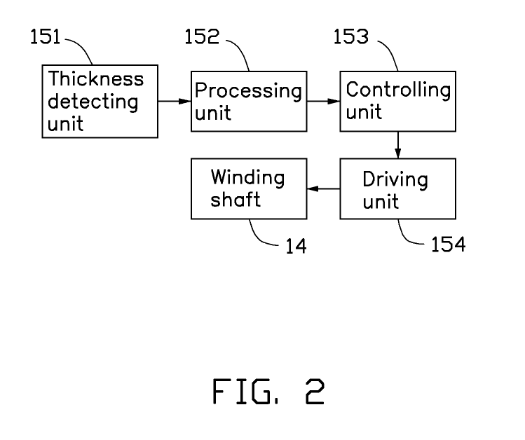

FIG. 2 illustrates an embodiment of the tension controller 15 of FIG. 1 coupled to the winding shaft 14. The tension controller includes a thickness detecting unit 151, a processing unit 152, a controlling unit 153, and a driving unit 154. The tension controller 15 is configured for adjusting a tension of the substrate film 20 during the roll-to-roll process. The driving unit 154 can drive the winding shaft 14 to rotate at different speeds.

The thickness detecting unit 151 is configured for detecting a thickness value of a coil of the substrate film 20 wound around the winding shaft 14. In this embodiment, the thickness detecting unit 15 can be an ultrasonic sensor.

The processing unit 152 is configured for calculating a suitable tension value of the substrate film 20 according to the thickness value detected by the thickness detecting unit 151. In detail, the processing unit 152 is programmed to calculate the suitable tension value of the substrate film 20 according to a predetermined linear relationship between the thickness value of the coil and the suitable tension value of the substrate film 20. In this embodiment, the tension of the substrate film 20 is adjusted to gradually decrease as the thickness of the coil of the base film 20 gradually increases around the winding shaft 14.

The controlling unit 153 is configured for controlling the driving unit 154 to adjust a rotating speed of the reeling shaft 14 according to the calculated suitable tension value. Because the unreeling shaft 11 rotates at a constant speed, the tension of the substrate film 20 can be reduced by slowing the rotating speed of the reeling shaft 14. In this embodiment, the driving unit 154 can be a motor.

In the roll-to-roll process, the substrate film 20 is unreeled from the unreeling shaft 11, passed through the pressing unit 12 and the guiding mechanism 13, and wound around the winding shaft 14. The unreeling shaft 11 is rotated to unreel the substrate film 20, the pressing unit 12 presses the substrate film 20 to print microstructures on at least one surface of the substrate film 20, the guiding mechanism guides the pressed substrate film 20 to the winding shaft 14, and the winding shaft 14 is rotated to wind the pressed substrate film 20 thereon. The thickness detecting unit 151 detects a thickness of the pressed substrate film 20 wound around the winding shaft 14. The processing unit 152 calculates a suitable tension value of the substrate film 20 according to a thickness value detected by the thickness detecting unit 151. The controlling unit 153 controls the driving unit 154 to adjust a rotating speed of the reeling shaft 14, thereby adjusting a tension of the substrate film 20 to the suitable tension value calculated by the processing unit 152. Therefore, the tension of the substrate film 20 can be timely adjusted according to a change in thickness of a coil of the substrate film 20 wound around the winding shaft 14, to prevent slipping of the base film 20 off the reeling shaft 14.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A roll-to-roll press device, comprising:
an unreeling shaft for supporting a coil of a substrate film thereon and unreeling the substrate film supported thereon;
a pressing unit for pressing the substrate film and to print microstructures on the substrate film;
a winding shaft for winding the pressed substrate film thereon;
a tension controller for adjusting tension of the pressed substrate film on the winding shaft according to a thickness of a coil of the substrate film wound around the winding shaft.

2. The roll-to-roll press device of claim 1, wherein the tension controller comprising:
a thickness detecting unit for detecting the thickness of the coil of the substrate film wound around the winding shaft;
a processing unit for calculating a suitable tension value of the substrate film according to a thickness value detected by the thickness detecting unit;
a driving unit for adjusting a tension of the substrate film; and
a controlling unit for controlling the driving unit to adjust the tension of the substrate film to the suitable tension value calculated by the processing unit.

3. The roll-to-roll press device of claim 2, wherein the thickness detecting unit is an ultrasonic sensor.

4. The roll-to-roll press device of claim 2, wherein the processing unit is programmed to calculate the tension value of the substrate film according to a predetermined linear relationship between the thickness of the coil of the substrate film on the winding shaft and the suitable tension of the substrate film.

5. The roll-to-roll press device of claim 2, wherein the processing unit is programmed to gradually decrease the suitable tension value with a gradual increasing of the thickness of the coil of the substrate film on the winding shaft.

6. The roll-to-roll press device of claim 1, wherein the pressing unit comprises a first pressing roller and a second pressing roller, and the first pressing roller and the second pressing roller are adapted to press the substrate film therebetween.

7. The roll-to-roll press device of claim 1, further comprising a guiding mechanism positioned between the unreeling shaft and the winding shaft for guiding the substrate film from the pressing unit to the winding shaft.

8. A roll press device, comprising:
an unreeling shaft for supporting a coil of a substrate film thereon and for unreeling the substrate film from the coil;
a pressing unit for pressing the unreeled substrate film to print microstructures on the unreeled substrate film;
a winding shaft for winding the pressed substrate film thereof;
a thickness detecting unit for detecting thickness of a coil of the substrate film wound around the winding shaft; and
a driving unit responsive to the detected thickness of the coil for driving at least one of the unreeling shaft and the winding shaft for adjusting tension of the pressed substrate film on the winding shaft according to the detected thickness of the coil.

9. The roll press device as claimed in claim 8, wherein the thickness detecting unit is an ultrasonic detector.

10. The roll press device as claimed in claim 8, further comprising a processing unit responsive to the detected thickness of the coil for calculating a tension value of the pressed substrate film on the winding shaft according to the detected thickness of the coil, and a controlling unit for controlling the driving unit so that the pressed substrate film has the tension value when wound upon the winding shaft.

11. The roll press device as claimed in claim 8, wherein the processing unit is programmed to calculate the tension value according to a predetermined linear relationship between the detected thickness of the coil and the tension value.

12. The roll press device as claimed in claim 8, wherein the processing unit is programmed to gradually decrease the tension value with a gradual increasing of the detected thickness of the coil.

13. The roll press device as claimed in claim 8, wherein the pressing unit comprises a first pressing roller and a second pressing roller, and the first pressing roller and the second pressing roller are adapted to press the substrate film there between.

14. The roll press device as claimed in claim 8, further comprising a guiding mechanism positioned between the unreeling shaft and the winding shaft for guiding the pressed substrate film from the pressing unit to the winding shaft.
